(19) United States
(12) Patent Application Publication
(10) Pub. No.: US 2013/0134278 A1
(43) Pub. Date: May 30, 2013

(54) CARTON STACKING STABILIZER ("CSS")

(71) Applicant: Shay Zeltzer, Tubac, AZ (US)

(72) Inventor: Shay Zeltzer, Tubac, AZ (US)

(21) Appl. No.: 13/305,574

(22) Filed: Nov. 28, 2011

(51) Int. Cl. F16M 13/00

(52) U.S. Cl. 248/351

(57) ABSTRACT

A stabilizer is provided for stabilizing a plurality of stacked box columns, wherein the stabilizer comprises a flat piece of cardboard, which further comprises at least four connected panels including at least two panels contoured to cause said cardboard piece to become a contiguous loop upon folding. The cardboard piece may be made contiguous in many ways including, but not limited to, by the use of a tab lock, a flap lock, or glue. In some embodiments, the unfolded stabilizer may have a triangular cross-section. In other embodiments, the unfolded stabilizer may have a rectangular cross-section. The stabilizer may be used to effectively stabilize stacks of boxes during transit in many different settings including, for example, to prevent palletized stacks of boxes containing products from collapsing during transportation over long distances.

### FIELD OF THE INVENTION

The field of the present invention relates to stabilization of cargo during transportation. More particularly, the field of the present invention relates to methods and apparatuses for stabilizing a plurality of stacked box columns while in transit, including by use of a stabilizer between two or more stacks of boxes.

### BACKGROUND OF THE INVENTION

All kinds of products are frequently transported for long distances. To prepare products for transport, products may be placed in boxes, crates or cartons that are then stacked upon one another. These stacks of boxes are typically placed on pallets so that they may be easily loaded onto a carrier vehicle.

But some boxes may shift during transport due to vibration or other force. This may cause some stacks of boxes to lean in one direction, and create vacancies or “chimneys” between such stacks on a pallet, and between stacks of boxes and the walls of a carrier vehicle. This in turn may permit some stacks to collapse upon themselves or onto the floor of the carrier vehicle. Collapsed stacks can damage the boxed products and also delay the transport of other products on the carrier vehicle.

“Dunnage” is used to stabilize stacks of boxes during transportation. “Dunnage” refers to non-valuable material or structures placed between and around valuable cargo to support and secure it during transportation. Several types of dunnage material are used in the product transportation industry today. For example, units of cargo may be supported by plastic air-filled dunnage bags, paper dunnage bags, or foam dunnage pieces. But dunnage is not necessarily secured to a cargo unit, such as a box or stack of boxes. Dunnage also may deflate or fall to the floor of a carrier vehicle due to vibrations during transportation. As such, dunnage may not adequately stabilize stacks of boxes during the full length of their transportation in a carrier vehicle.

Olvey (U.S. Pat. No. 7,426,890) teaches construction of a force-resisting assembly from corrugated or solid paperboard blanks, which may be used as either a pallet or as dunnage support. A lower and an upper frame member comprise ribs with alignment/locking slots to form the assembly. The ribs of the lower frame member align/lock with the alignment/locking slots of the ribs of the upper frame member, and vice versa. When used as a dunnage support, the Olvey assembly is placed between two or more surfaces to resist transport forces that may shift the surfaces toward one another. The Olvey assembly aims to help protect shock-sensitive components such as electrical and electronic devices. The Olvey assembly may face the same limitations of traditional dunnage with respect to stabilizing stacks of boxes during transportation. The assembly may shift or fall during transportation and thereby lose its ability to resist forces between surfaces.

Ogilvie (U.S. Pat. No. 6,029,582) teaches a force-resisting corrugated assembly, which can be constructed into a pallet or dunnage support. The Ogilvie assembly comprises lower and upper frame members foldably constructed from cardboard blanks. Each frame member comprises ribs with locking slots. To create the assembly from these members, the upper frame member is rotated 90 degrees relative to the lower frame member and placed upside down over the lower frame member. The lower frame member's ribs lock into the locking slots of the upper frame member's ribs, and vice versa. When used as dunnage, the Ogilvie assembly is placed between two or more surfaces, and resists forces generated when the surfaces move toward one another during transportation. If used to stabilize stacks of boxes during transportation, the Ogilvie assembly will likely face the same drawbacks as the Olvey assembly and other dunnage materials, which may shift or fall during transit relative to the cargo.

Thus there exists a need to stabilize stacks of boxes during transportation, to prevent vacancies which can cause a stack to collapse, and to secure the stabilizer to prevent it from shifting or falling out of place during transit.

### SUMMARY

The present patent application discloses methods and apparatuses to stabilize stacked box columns during transit by placing a stabilizer between at least two of stacks of boxes. According to one aspect, the stabilizer is suspended from the stacks of boxes to ensure the stabilizer remains in place during transit, and to provide a stable support for additional stacks of boxes. Another aspect discloses a locking mechanism that may be located on two or more panels and which causes a flat cardboard blank to become and remain contiguous.

In a preferred embodiment reflecting a further aspect, the apparatuses described herein may be a cardboard blank comprising a flat cardboard with one or more layers of fluting; said blank further comprising four or more connected panels separated by folding lines; at least one panel which can suspend the cardboard blank from two or more stacks of boxes when folded; and two or more panels which can interact to cause the flat cardboard to become a contiguous loop, while still being expandable.

A further aspect provides a method to stabilize stacked box columns comprising the steps of: placing a folded cardboard blank into a vacancy or “chimney” between two or more stacks of boxes; expanding the cardboard blank; and suspending this folded, expanded cardboard blank from the stacks of boxes so that the folded, expanded cardboard blank creates a support for two or more stacks of boxes, wherein the horizontal support is provided by the cardboard blank's horizontal fluting.

In addition, another aspect provides a separate method of stabilizing stacked box columns comprising the steps of: positioning a folded cardboard blank within an opening between two or more stacks of boxes; expanding this cardboard blank; and suspending the folded, expanded cardboard blank from the stacks of boxes to provide a horizontal support for two or more stacks of boxes, wherein a lock makes the folded cardboard blank contiguous.

The foregoing methods may produce a stabilizer with a triangular, rectangular or other shaped cross-section. The aforementioned methods and apparatuses may further comprise a stabilizer with a locking mechanism employing a tab lock or a flap lock. In addition, the stabilizer may be made a contiguous loop by the use of glue.

### DESCRIPTION OF THE FIGURES

FIG. 1 is a bird's-eye view of a flat cardboard blank which may be folded into a first embodiment.

FIG. 2 is a perspective view of a cardboard blank which has been folded into a first embodiment, and then partially expanded.

FIG. 3 is a bird's-eye view of an unfolded cardboard blank which may be folded into a second embodiment.

FIG. 4 is a perspective view of a cardboard blank which has been folded into a second embodiment, and then partially expanded.

FIG. 5 is a bird's-eye view of an unfolded cardboard blank which may be folded into a third embodiment.

FIG. 6 is a perspective view of a cardboard blank which has been folded into a third embodiment, and then expanded.

FIGS. 7A-7E show a perspective view of the first embodiment being deployed into an opening between stacks of boxes.

### DETAILED DESCRIPTION

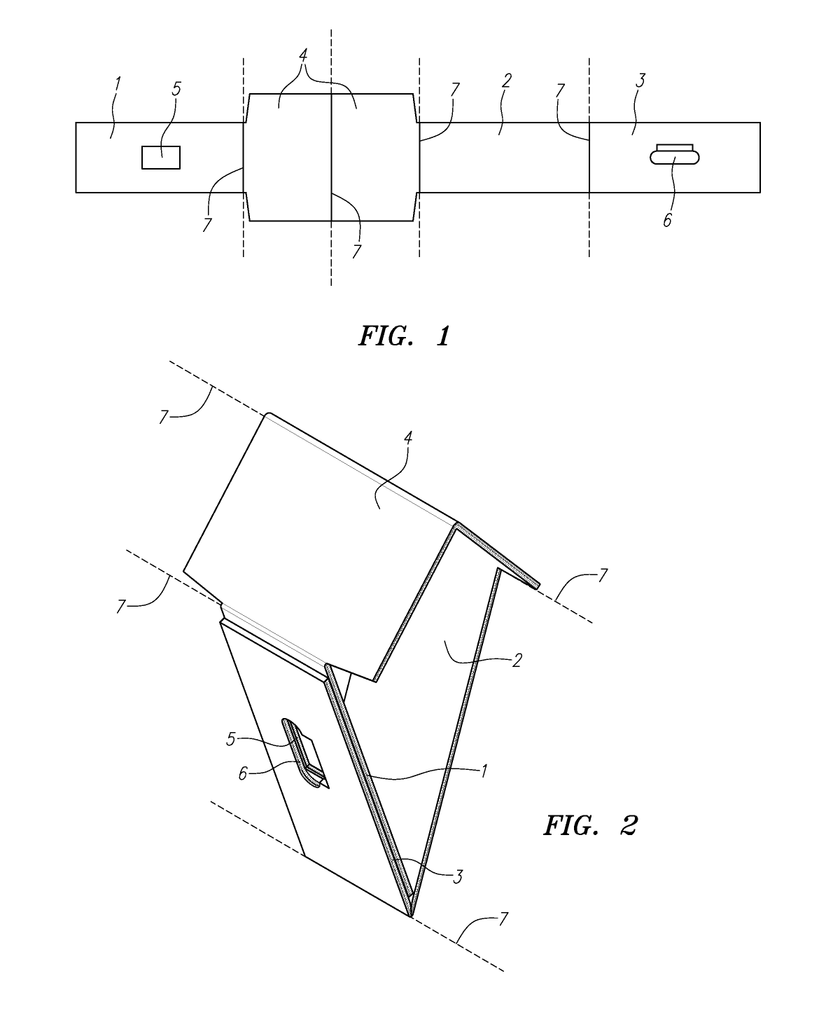

FIG. 1 shows a flat cardboard blank that may be folded into a first embodiment that has a triangular cross-section when unfolded. Panels 1, 2, 3 and 4 are folded along folding lines 7 to bring panel 3 on top of panel 1, creating a nearly contiguous shape. In this embodiment, panels 1, 2, and 3 are folded to form the bottom portion of the stabilizer, while panel 4 forms the top of the stabilizer. Panels 1 and 3 include a tab hole 5 and tab 6, respectively. Panel 1 is folded such that it lies inside panel 3, and such that tab hole 5 lies flush with and on the inside of tab 6. Then, tab 6 is inserted into tab hole 5, and tab 6 is folded through tab hole 5, to form a tab lock which makes the cardboard blank a contiguous loop. Panel 4 is folded along folding line 7 to facilitate compressing the now-contiguous cardboard blank into a two-dimensional form.

Referring now to FIG. 2, the folded form of this first embodiment is placed in an opening between stacks of boxes and expanded by pulling panels 3 and 1 away from panel 2. Panel 4 becomes flat once again, as a result of expansion, and the triangular cross-section of this first embodiment becomes evident. The expanded, contiguous cardboard blank is inserted into an opening between stacks of boxes. When fully expanded, the free edges of panel 4 hang from the tops of each stack of boxes thereby suspending the stabilizer in the opening. Horizontal support for the stacks of boxes is provided by horizontal fluting (not shown) within panels 1, 2 and 3.

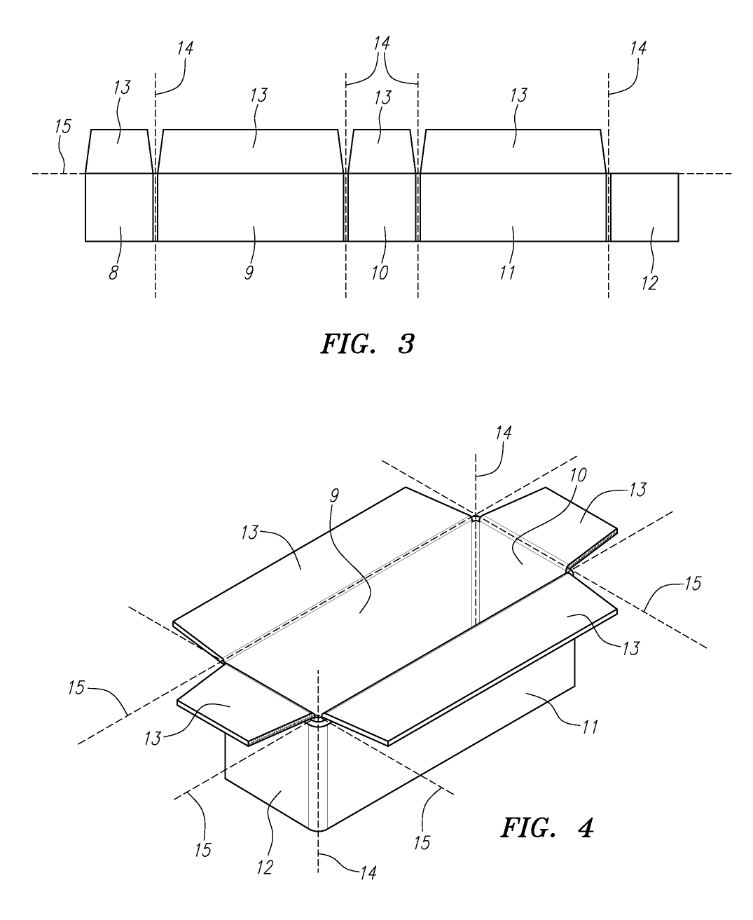

In FIG. 3, a flat cardboard blank is shown which may be folded into a second embodiment. This embodiment will have a rectangular cross-section when expanded. Panels 8, 9, 10, 11 and 12 are folded along folding lines 14 to bring panel 12 on top of panel 8, creating a nearly contiguous shape. In this embodiment, panels 8, 9, 10, 11, and 12 are folded to form the bottom portion of the stabilizer, while panels 13 form the top of the stabilizer. Glue may be applied to either panel 8 or panel 12 to secure panel 12 to the outside of panel 8, making the cardboard blank a contiguous loop. The contiguous cardboard blank is folded along any two diagonally opposite folding lines 14 to facilitate compressing the cardboard blank into a two-dimensional form.

Referring now to FIG. 4, the folded form of this second embodiment is placed in an opening between stacks of boxes and expanded by pushing any two diagonally opposite folding lines 14 towards each other, causing the folded, contiguous cardboard blank to expand. As a result, space is created within the contiguous shape formed by panels 9, 10, and 11, and conjoined panels 8 and 12, and the rectangular cross-section of this second embodiment becomes evident. Panels 13 are now folded down along folding lines 15 to make them perpendicular to panels 9, 10, and 11, and conjoined panels 8 and 12, rendering panels 13 similar to the petals of a flower. The contiguous cardboard blank is inserted into an opening between stacks of boxes. When fully expanded, the free edges of panels 13 hang from the tops of each stack of boxes, thereby suspending the stabilizer in the opening. Horizontal support for the stacks of boxes is provided by horizontal fluting (not shown) within panels 8, 9, 10, 11, and 12.

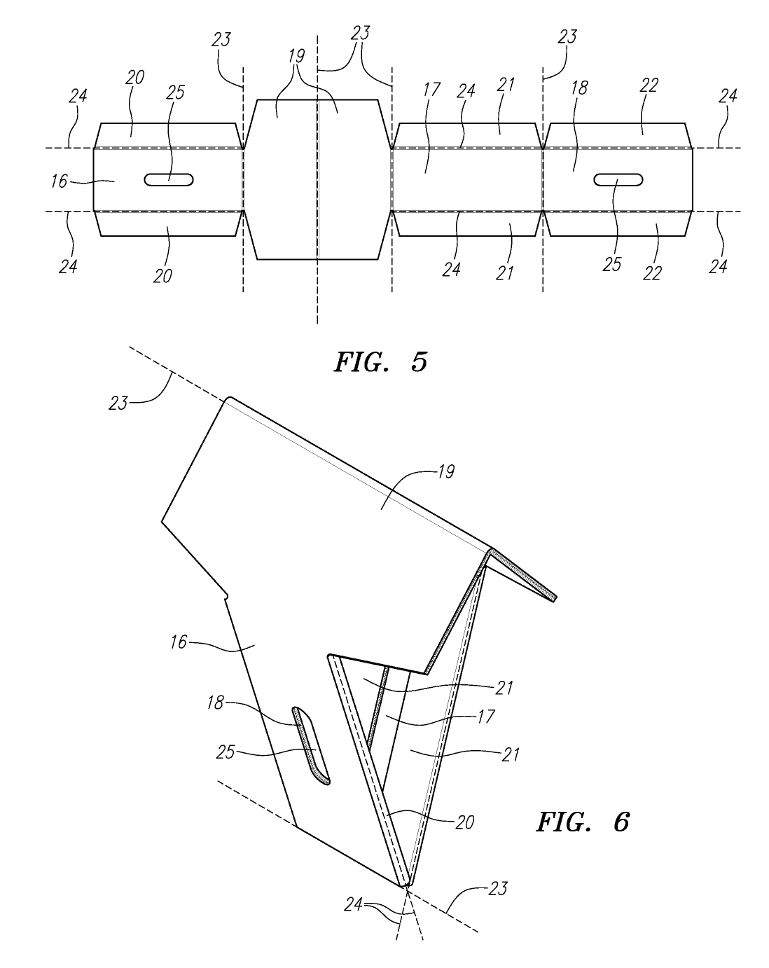

FIG. 5 depicts a flat cardboard blank that may be folded into a third embodiment with a triangular or other shaped cross-section when expanded. Panels 16, 17, 18 and 19 are folded along folding lines 23 to bring panel 16 on top of panel 18, creating a nearly contiguous shape. In this embodiment, panels 16, 17, and 18 are folded to form the bottom portion of the stabilizer, while panel 19 forms the top of the stabilizer. Panels 16, 17, and 18 include flaps 21 along each of their edges. Flaps 21 on panels 17 and 18 are folded inwards along folding lines 24, so that flaps 21 lie on the insides of panels 17 and 18. Panel 18 is folded such that it lies on the inside of panel 16. Flaps 21 on panel 16 are then folded around panel 18 and flaps 21 on panel 18, such that panel 18 is enveloped within flaps 21 on panel 16. This forms a flap lock which makes the cardboard blank contiguous. Panel 19 is folded along folding line 23 to facilitate compressing the now contiguous cardboard blank into a two-dimensional form.

FIG. 6 shows the third embodiment after the folded form of the stabilizer is placed in an opening between stacks of boxes. The embodiment is expanded by pulling panels 16 and 18 away from panel 17. According to this embodiment, after expansion, the panel 19 becomes flat once again, and the preferably triangular cross-section of this third embodiment becomes evident. The contiguous cardboard blank is inserted into an opening between stacks of boxes. When fully expanded, the free edges of panel 19 hang from the tops of each stack of boxes, thereby suspending the stabilizer. Horizontal support for the stacks of boxes is provided by horizontal fluting (not shown) within panels 16, 17 and 18.

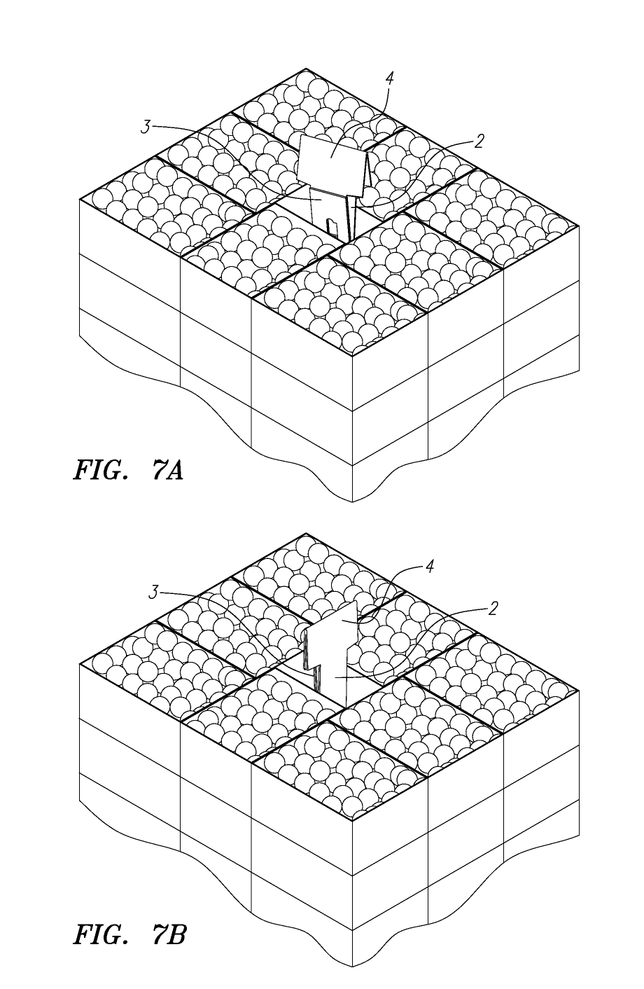

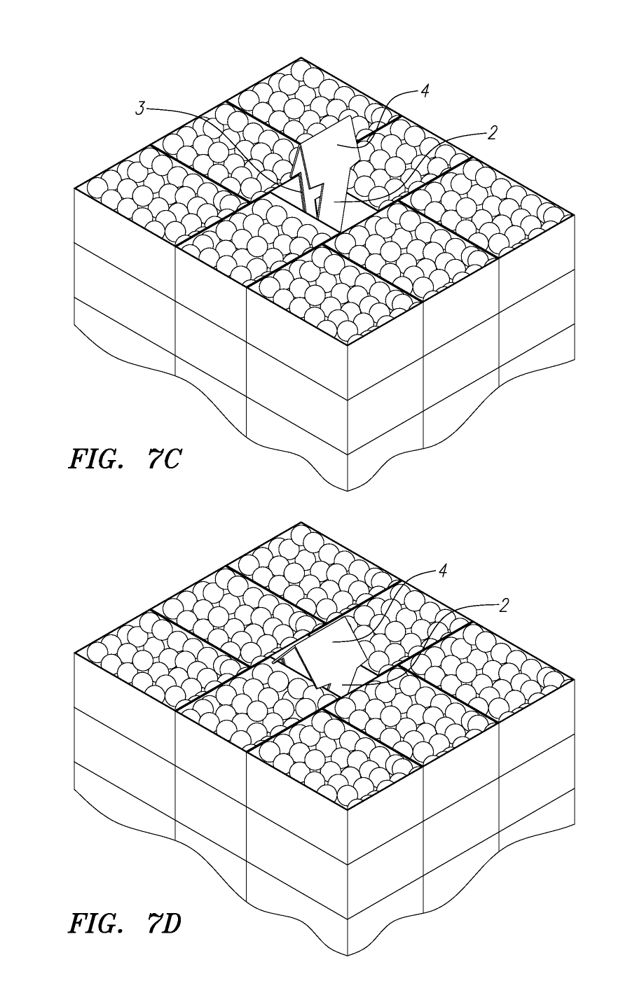

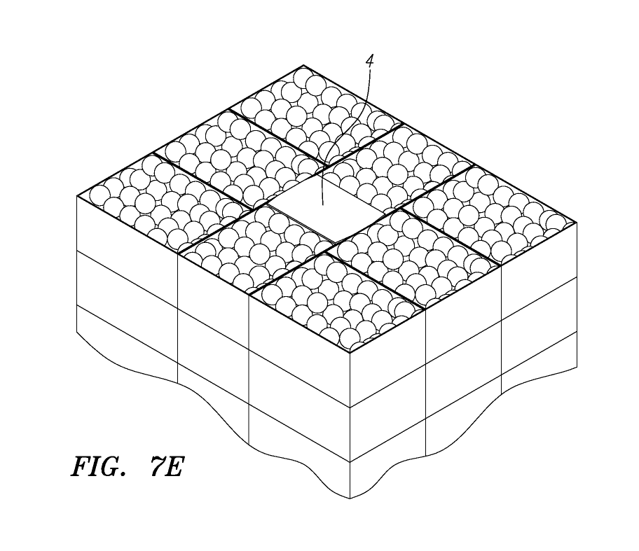

FIG. 7A shows the first embodiment with the folded form of the stabilizer placed in an opening between stacks of boxes.

FIG. 7B shows the first embodiment with the folded form of the stabilizer aligned substantially perpendicular to the edges of the boxes.

FIG. 7C shows the first embodiment with panels 1 and 2 separated to form a narrow “V” shape.

FIG. 7D shows the first embodiment with panels 1 and 2 further separated to form a wider “V” shape.

FIG. 7E shows the first embodiment with panels 1 and 2 (not shown) fully expanded such that the free edges of the top panel hang from the tops of each stack of boxes, thereby suspending the stabilizer. Horizontal fluting within panels 1 and 2 (not shown) may provide additional strength to support the stacks of boxes.

We claim:

1. A stabilizer for stabilizing a plurality of stacked box columns, the stabilizer comprising:
a flat cardboard;
said flat cardboard further comprising at least four connected panels separated by folding lines;
at least two panels contoured by said folding lines to cause said flat cardboard to become a contiguous loop upon folding; and
at least one panel contoured by said folding lines to suspend the stabilizer from at least two stacks of boxes upon expansion.

2. The stabilizer of claim 1, wherein the folded stabilizer has a triangular cross-section.

3. The stabilizer of claim 1, wherein the folded stabilizer has a rectangular cross-section.

4. The stabilizer of claim 1, wherein the flat cardboard is made contiguous by a tab lock, comprising:
at least one hanging tab in one panel of said flat cardboard; and
at least one tab-sized hole capable of receiving said hanging tab in another panel of said flat section.

5. The stabilizer of claim 1, wherein the flat cardboard is made contiguous by a flap lock, comprising:
at least one flapped panel of said flat cardboard; and
at least one other panel of the flat section which may be received by said flapped panel of the flat section.

6. A cardboard blank for stabilizing a plurality of stacked box columns, the cardboard blank comprising:
at least one flat piece of cardboard;
wherein said flat piece of cardboard further comprises at least four continuous panels, wherein said panels are formed on said flat piece and are separated by folding lines;
at least two panels shaped by said folding lines so that the blank becomes a contiguous loop upon folding; and
at least one panel shaped by said folding lines to cause the cardboard blank to be suspended from at least two stacks of boxes upon expansion.

7. The cardboard blank of claim 6, wherein the folded, expanded cardboard blank has a triangular cross-section.

8. The cardboard blank of claim 6, wherein the folded, expanded cardboard blank has a rectangular cross-section.

9. The cardboard blank of claim 6, wherein the flat piece of cardboard is made contiguous by a tab lock, comprising:
at least one hanging tab in one panel of said flat piece; and
at least one tab-sized hole capable of receiving said hanging tab in another panel of said flat piece.

10. The cardboard blank of claim 6, wherein the flat piece of cardboard is made contiguous by a flap lock, comprising:
at least one flapped panel of said flat piece; and
at least one other panel of the flat piece which may be received by said flapped panel of the flat piece.

11. A method of stabilizing a plurality of stacked box columns comprising the steps of:
inserting a folded cardboard blank into an opening between at least two stacks of boxes;
expanding said cardboard blank; and
suspending said folded cardboard blank from said stacks of boxes such that said folded cardboard blank provides a horizontal support for at least two of said stacks of boxes.

12. The method of claim 1, wherein the steps are performed in the listed order.

13. The method of claim 1, wherein the folded, expanded cardboard blank has a triangular cross-section.

14. The method of claim 1, wherein the folded, expanded cardboard blank has a rectangular cross-section.

15. The method of claim 1, wherein the folded cardboard blank is made a contiguous loop by the use of glue.

16. A method of stabilizing a plurality of stacked box columns comprising the steps of:
inserting a folded cardboard blank into an opening between at least two stacks of boxes;
expanding said cardboard blank; and
suspending said folded, expanded cardboard blank from said stacks of boxes such that said folded, expanded cardboard blank provides a horizontal support for at least two of said stacks of boxes, wherein said folded cardboard blank is made contiguous by virtue of a lock.

17. The method of claim 6, wherein the lock is a tab lock, comprising:
at least one hanging tab in one panel of the cardboard blank; and
at least one tab-sized hole capable of receiving said hanging tab in another panel of the cardboard blank.

18. The method of claim 16, wherein the lock is a flap lock, comprising:
at least one flapped panel of the cardboard blank; and
at least one other panel of the cardboard blank which may be received by said flapped panel of the cardboard blank.

19. The method of claim 16, wherein the folded, expanded cardboard blank has a triangular cross-section.

20. The method of claim 16, wherein the folded, expanded cardboard blank has a rectangular cross-section.

21. The method of claim 16, wherein the steps are performed in the listed order.
